(19) United States
(12) Patent Application Publication
(10) Pub. No.: US 2016/0093418 A1
(43) Pub. Date: Mar. 31, 2016

(54) INSULATED CONDUCTOR ASSEMBLY AND METHOD OF ITS MANUFACTURING

(71) Applicant: TELEFONAKTIEBOLAGET L M ERICSSON (PUBL), Stockholm (SE)

(72) Inventors: Lars EFRAIMSSON, Falun (SE); Johan ÄHMAN, Falun (SE); Joakim JÖRGENSEN, Hudiksvall (SE); Anders LINDROTH, Hudiksvall (SE); Stefan SÖDERSTRÖM, Hudiksvall (SE); Johan SVANBERG, Hudiksvall (SE); Anders GATU, Vikarbyn (SE)

(21) Appl. No.: 14/787,959

(22) PCT Filed: May 15, 2013
(86) PCT No.: PCT/EP2013/060066

§ 371 Date: Oct. 29, 2015

(30) Foreign Application Priority Data
Apr. 30, 2013 (EP) PCT/EP2013/058938

(51) Int. Cl. H01B 7/285; G02B 6/44; H01B 3/44; H01B 9/00; H01B 13/32

(52) U.S. Cl. CPC H01B 7/285; H01B 9/005; H01B 13/32; H01B 3/441; G02B 6/4459

(57) ABSTRACT

An insulated conductor assembly is provided. The assembly comprises at least two insulated conductors, a jacket enclosing the at least two insulated conductors, and a filling compound arranged between the jacket and the at least two insulated conductors. The assembly comprises first sections, extending along the assembly, completely filled with the filling compound between the jacket and the at least two insulated conductors, and second sections, extending along the assembly, void of filling compound between the jacket and the at least two insulated conductors. Further a method of manufacturing an insulated conductor assembly and a manufacturing arrangement for manufacturing an insulated conductor assembly are provided.

### TECHNICAL FIELD

The technical field relates to insulated conductor assemblies, methods of manufacturing insulated conductor assemblies, and to manufacturing arrangements for manufacturing such assemblies.

### BACKGROUND

An insulated conductor assembly comprises at least one insulated electrical conductor and/or at least one insulated optical conductor, such as an optical fibre. An insulated conductor assembly may form a cable, or may form part of a cable.

An insulated connector assembly connects a first or second connection point, such as electrical or optical terminations, or apparatuses. Via an optical fibre in an insulated conductor assembly, optical communication between a first and a second apparatus is made possible. Via an electric conductor in an insulated conductor assembly an electrical connection between a first and a second apparatus is made possible.

A longitudinally unsealed insulated conductor assembly with an open end or a damaged outer jacket will allow transport of water along the inside of the assembly. Water at a high location will create a pressure inside the assembly at a low location. An apparatus connected to the relevant assembly at the low location will thus be subjected to the water in the assembly. A connection between the assembly and the apparatus, or the apparatus itself has to be devised to withstand water.

There exists a need for an insulated conductor assembly, which will not conduct water if the insulated conductor assembly should be damaged.

### SUMMARY

An object is to provide a longitudinally water blocking insulated conductor assembly.

According to an aspect, the object is achieved by an insulated conductor assembly comprising at least two insulated conductors, a jacket enclosing the at least two insulated conductors, and a filling compound arranged between the jacket and the at least two insulated conductors. The insulated conductor assembly comprises first sections, extending along the insulated conductor assembly, completely filled with the filling compound between the jacket and the at least two insulated conductors. The insulated conductor assembly further comprises second sections, extending along the insulated conductor assembly, void of filling compound between the jacket and the at least two insulated conductors.

Since the filling compound completely fills the first sections as defined above, any water in the insulated conductor assembly is prevented from being transported along the insulated conductor assembly. As a result, the above mentioned object is achieved.

It has been realized by the inventors that in many cases it may suffice that an insulated conductor assembly intermittently blocks water. This comes from the realization that a damaged jacket of the insulated conductor assembly will admit water only into the insulated conductor assembly in a relevant second section. The two first sections adjacent to the damaged jacket will prevent water from propagating along the length of the insulated conductor assembly thus, preventing secondary damage such as apparatus failure when reaching apparatuses connected at the ends of a relevant insulated conductor assembly. Any water damage may thus be limited.

A insulated conductor assembly comprising first and second sections mentioned above has further advantages such as light weight, lower material costs, higher flexibility, and it is more easily to open for installation purposes—compared to an insulated conductor assembly filled with filling compound and without second sections void of filling compound. The higher flexibility provides easy handling during installation, which may be beneficial at least in insulated conductor assembly installations in narrow spaces.

An insulated conductor assembly comprises a number of insulated conductors organized in a certain pattern. An insulated conductor assembly may form a cable, or may form part of a cable. An insulated conductor assembly may comprise insulated conductors only, or a combination of insulated conductors and ducts. The insulated conductors are protected by a jacket. The insulated conductors may have any suitable cross section shape. A round cross section is a typical cross section shape of the insulated conductors. The insulated conductor assembly may have any suitable cross section shape. A round, oval, or flat cross section shape is common. An insulated conductor assembly connects at least a first and a second apparatus. An insulated conductor assembly may be used for connecting first and second apparatuses over long distances, e.g. in the range of kilometres. Via an optical conductor, such as an optical fibre, in an insulated conductor assembly, optical communication between a first and a second apparatus is made possible. Via an electric conductor in an insulated conductor assembly, an electrical connection between a first and a second apparatus is made possible. Examples of apparatuses which may be connected by optical fibres or electric conductors in an insulated conductor assembly may be complex apparatuses such as telecommunication equipment, computers, and data processing equipment, or simple apparatuses such as various connectors for connecting optical fibres or electric conductors to relevant equipment and relays for optical or electrical signals. Also power cables for transfer of electrical energy are examples of insulated conductor assemblies. A jacket of the insulated conductor assembly may be formed by extrusion around the insulated conductors, or by taping around the insulated conductors, or combinations thereof. A tape comprised in a jacket of an insulated conductor assembly may comprise one or more polymeric and/or metal layers. The jacket may comprise one or more screens, which may be formed e.g. by taping or weaving.

Herein, the terms “completely fill” and “completely filled” are to be interpreted as all spaces between the jacket and the insulated conductors, as well as all spaces between the insulated conductors themselves, in a cross section of the insulated conductor assembly are filled out. No cavities are present in the cross section, except off course in the channels of the ducts and in spaces between single conductor strands of a conductor. The cross section is perpendicular to an extension of the insulated conductor assembly.

Herein, the term “insulated conductor” refers to a composition comprising at least one conductor and at least one insulator enclosing the conductor in tight abutment. The insulated conductor may comprise a metallic electrical conductor used for the transmission of electrical energy between two points. The insulated conductor may alternately comprise a metallic conductor for the transmission of electrical signals between two points. The insulated conductor may comprise an optical fibre for conducting optical signals there through.

Herein, a duct forms a channel for subsequent installation of an optical or electrical conductor. A duct, sometimes referred to as a micro duct, comprises a plastic tube adapted to receive an optical fibre or an electric conductor. A duct forms a channel for an optical fibre or an electric conductor. An optical fibre or an electric conductor may be installed in a duct by blowing technique.

Although also conductors extending along ducts are insulated from each other by means of the ducts, herein, the term “insulated conductor” refers to a composition comprising at least one conductor and at least one insulator enclosing the conductor in tight abutment. As opposed to a duct, wherein a conductor must have a smaller diameter than an inner diameter of a relevant duct in order to allow the conductor to be introduced into the duct.

According to embodiments, interspaces may be formed between the at least two insulated conductors, the interspaces in the first sections being completely filled with the filling compound, and wherein the interspaces in the second sections are void of filling compound. In this manner interspaces are also filled with the filling compound to prevent any water from passing the first sections. These embodiments are of particular relevance when the insulated conductor assembly comprises insulated conductors formed such that interspaces are formed therebetween, e.g. in the case of more than two insulated conductors having circular cross sections.

A further object is to provide a method of manufacturing a longitudinally water blocking insulated conductor assembly.

According to an aspect, the object is achieved by a method of manufacturing an insulated conductor assembly, the method comprising:
feeding at least three insulated conductors along a feeding direction through a passage of a die, the at least three insulated conductors being separated from each other at a first position of the die,
injecting a first amount of filling compound into the passage at the first position,
moving the at least three insulated conductors towards each other at a first portion of the die, the first portion being arranged after the first position seen along the feeding direction, and
forming a jacket around the at least three insulated conductors and the filling compound.

Since the at least three insulated conductors are separated from each other at the first position of the die, were the filling compound is injected into the die, and thereafter the at least three insulated conductors are moved towards each other, it is ensured that interspaces between the at least three insulated conductors are filled with filling compound. As a result, the method produces an insulated conductor assembly with filling compound between the insulated conductors, and the above mentioned object is achieved.

An insulated conductor assembly manufactured according to the method may comprise insulated conductors only, or a combination of insulated conductors and ducts. The forming a jacket around the at least three insulated conductors and the filling compound may comprise; extruding a jacket, and/or forming a jacket by taping, or combinations thereof.

According to embodiments, the method may further comprise:
injecting a second amount of filling compound into the passage at a second position of the die, the second position being arranged after the first portion, seen along the feeding direction. In this manner it need not be relied upon that the first amount of filling compound will suffice to fill out also spaces between the jacket and the at least three insulated conductors. The second amount of filling compound will be arranged to fill out any remaining spaces otherwise formed between the jacket and the at least three insulated conductors.

According to embodiments, the method may further comprise:
intermittently stopping the injecting the first amount of filling compound and the injecting the second amount of filling compound while continuing the feeding and the forming, to thereby form an insulated conductor assembly comprising first sections completely filled with the filling compound between the jacket and the at least three insulated conductors as well as between the at least three insulated conductors, and second sections void of filling compound between the jacket and the at least three insulated conductors as well as between the at least three insulated conductors. In this manner it may be ensured that the insulated conductor assembly is watertight along the first sections.

It has been realized by the inventors that in many cases it may suffice for an insulated conductor assembly to intermittently block water. This comes from the realization that a damaged jacket of the insulated conductor assembly will admit water only into the insulated conductor assembly in a relevant second section. The two first sections adjacent to the damaged jacket will prevent water from reaching apparatuses connected at the ends of a relevant insulated conductor assembly.

In some embodiments it may be possible to use 1/10 or less of the filling compound, compared to an insulated conductor assembly filled with filling compound and without second sections void of filling compound.

A further object is to provide a manufacturing arrangement for manufacturing a longitudinally water blocking insulated conductor assembly.

According to an aspect, the object is achieved by a manufacturing arrangement for manufacturing a insulated conductor assembly. The manufacturing arrangement comprises a die and a jacket forming arrangement. The die comprises a passage extending through the die for feeding at least three insulated conductors along a feeding direction there through. The die comprises a first injection arrangement for filling compound arranged at a first position along the feeding direction and a first portion of the die. The first injection arrangement is connected to the passage. The first portion is arranged after the first position seen along the feeding direction. The first portion is arranged to move the at least three insulated conductors towards each other.

Since the die is provided with the first injection arrangement for filling compound arranged at the first position before the first portion, which is arranged to move the at least three insulated conductors towards each other, it is ensured that interspaces between the at least three insulated conductors are filled with filling compound in an insulated conductor assembly manufactured in the die. As a result, in the manufacturing arrangement an insulated conductor assembly with filling compound between the insulated conductors may be manufactured, and the above mentioned object is achieved.

The manufacturing arrangement may form part of an extruder for forming the insulated conductor assembly. The die may form part of an extruder head of the extruder. Suitably, the die is arranged before the jacket forming arrangement. The jacket forming arrangement may comprise e.g. a jacket extruding arrangement, and/or a jacket taping arrangement. Jacket extruding arrangements and jacket taping arrangements as such are known in the art.

According to embodiments, the passage may be wider at an inlet end for the at least three insulated conductors than at an outlet end for the at least three insulated conductors and the filling compound. In this manner it may be ensured that the at least three insulated conductors are moved towards each other as they pass through the passage, during manufacturing of an insulated conductor assembly.

According to embodiments, the die may comprise a second injection arrangement for filling compound arranged at a second position of the die along the feeding direction, the second position being arranged after the first portion of the die, seen along the feeding direction, wherein the second injection arrangement is connected to the passage. In this manner it may be ensured that any remaining spaces between the jacket and the at least three insulated conductors are filed with filling compound.

A further object is to provide a longitudinally water blocking insulated conductor assembly.

According to an aspect, the object is achieved by an insulated conductor assembly comprising at least three insulated conductors, a jacket enclosing the at least three insulated conductors, and a filling compound arranged between the jacket and the at least three insulated conductors. Filling compound is further arranged between the at least three insulated conductors to completely fill out interspaces there between, to form an insulated conductor assembly at least partially void of cavities.

Since the filling compound is arranged between the jacket and the at least three insulated conductors as well as in the interspaces between the at least three insulated conductors, any water in the insulated conductor assembly is prevented from being transported along the insulated conductor assembly. As a result, the above mentioned object is achieved.

Again, an insulated conductor assembly comprises a number of insulated conductors organized in a certain pattern. An insulated conductor assembly may form a cable, or may form part of a cable. An insulated conductor assembly may comprise insulated conductors only, or a combination of insulated conductors and ducts. The insulated conductors are protected by a jacket. The insulated conductors may have any suitable cross section shape. A round cross section is a typical cross section shape of the insulated conductors. The insulated conductor assembly may have any suitable cross section shape. A round, oval or flat cross section shape is common. An insulated conductor assembly connects at least a first and a second apparatus. An insulated conductor assembly may be used for connecting first and second apparatuses over long distances, e.g. in the range of kilometres. Via an optical connector, such as an optical fibre, in an insulated conductor assembly, optical communication between a first and a second apparatus is made possible. Via an electric conductor in an insulated conductor assembly, an electrical connection between a first and a second apparatus is made possible. Examples of apparatuses which may be connected by optical fibres or electric conductors in an insulated conductor assembly may be complex apparatuses such as telecommunication equipment, computers, and data processing equipment, or simple apparatuses such as various connectors for connecting optical fibres or electric conductors to relevant equipment and relays for optical or electrical signals. Also power cables for transfer of electrical energy in an electrical supply system are examples of insulated conductor assemblies. A jacket of the insulated conductor assembly may be formed by extrusion around the insulated conductors, or by taping around the insulated conductors, or combinations thereof. A tape comprised in a jacket of an insulated conductor assembly may comprise one or more polymeric and/or metal layers. The jacket may comprise one or more screens, which may be formed e.g. by taping or weaving.

According to embodiments, first spaces between the jacket and the at least three insulated conductors are intermittently filed with the filling compound, and the interspaces are intermittently filed with the filling compound such that the insulated conductor assembly comprises first sections completely filled with the filling compound between the jacket and the at least three insulated conductors as well as between the at least three insulated conductors, and second sections void of filling compound between the jacket and the at least three insulated conductors as well as between the at least three insulated conductors. In this manner it may be ensured that the insulated conductor assembly is watertight along the first sections.

It has been realized by the inventors that in many cases it may suffice for an insulated conductor assembly to intermittently block water. This comes from the realization that a damaged jacket of the insulated conductor assembly will admit water only into the insulated conductor assembly in a relevant second section. The two first sections adjacent to the damaged jacket will prevent water from propagating along the length of the insulated conductor assembly and reaching apparatuses or terminations connected at the ends of a relevant insulated conductor assembly.

An insulated conductor assembly comprising first and second sections mentioned above has further advantages such as light weight, lower material costs, higher flexibility, and it is more easily to open for installation purposes—compared to an insulated conductor assembly filled with filling compound and without second sections void of filling compound. The higher flexibility provides easy handling during installation, which may be beneficial at least in insulated conductor assembly installations in narrow spaces.

According to embodiments, along the insulated conductor assembly the first sections and the second sections may be distributed at a ratio of 1/20-1/5. That is, between 1/20 and 1/5 of a length along the insulated conductor assembly may comprise first sections. The remainder may comprise second sections. In this manner a distribution of first and second sections suitable for blocking water along the insulated conductor assembly may be achieved.

Further features of and advantages with embodiments herein will become apparent when studying the appended claims and the following detailed description. Those skilled in the art will realize that different features of embodiments may be combined to create embodiments other than those described in the following, without departing from the scope as defined by the appended claims.

### BRIEF DESCRIPTION OF THE DRAWINGS

The various aspects, including particular features and advantages, will be readily understood from the following detailed description and the accompanying drawings, in which:

FIGS. 1a and 1b illustrate an insulated conductor assembly according to embodiments and partial cross sections through the insulated conductor assembly,

FIGS. 2a and 2b illustrate enlarged cross sections of insulated conductor assemblies according to embodiments,

FIG. 3 illustrates schematically embodiments of a method of manufacturing an insulated conductor assembly,

FIGS. 4 and 5 illustrates embodiments of a manufacturing arrangement for manufacturing an insulated conductor assembly, and

FIG. 6 illustrates a partial cross section through an insulated conductor assembly according to embodiments.

### DETAILED DESCRIPTION

Example embodiments will now be described more fully with reference to the accompanying drawings. Disclosed features of example embodiments may be combined as readily understood by one of ordinary skill in the art. Like numbers refer to like elements throughout. Well-known functions or constructions will not necessarily be described in detail for brevity and/or clarity.

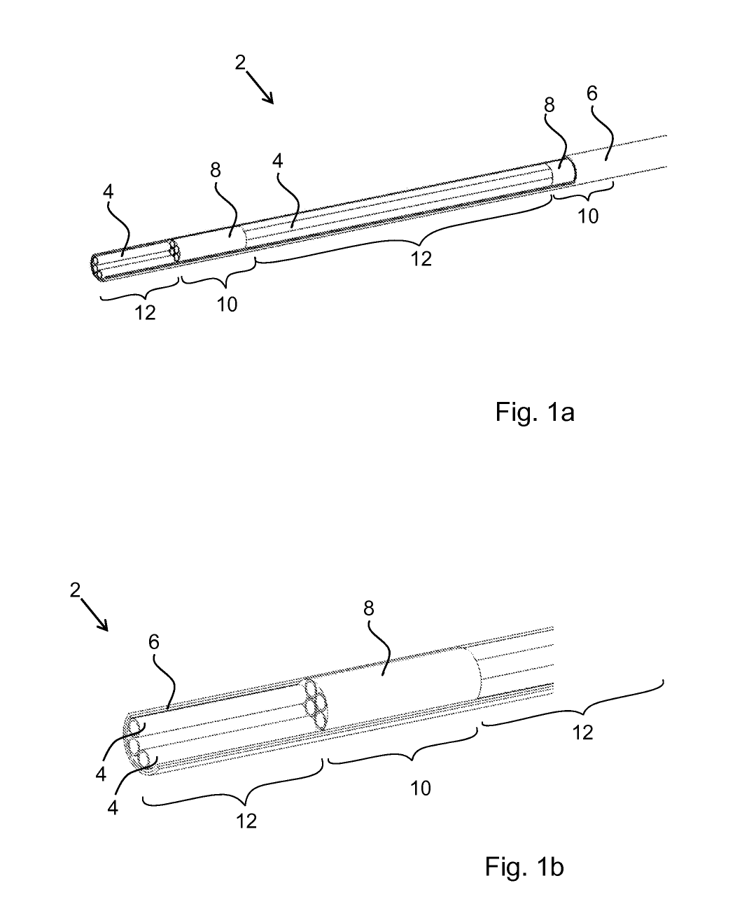

FIGS. 1a and 1b illustrate an insulated conductor assembly 2 according to embodiments and partial cross sections through the insulated conductor assembly 2. Herein, the insulated conductor assembly 2 may alternatively be referred to as the assembly 2. The assembly 2 comprises at least two insulated conductors 4. These embodiments are illustrated with 7 conductors 4. However, the assembly 2 may comprise any number of insulated conductors 4. Provided purely as an example, the number of insulated conductors 4 may range between 2 and 26, higher numbers of insulated conductors 4 are also conceived of. A jacket 6 encloses the insulated conductors 4. A filling compound 8 is arranged between the jacket 6 and the insulated conductors 4.

More specifically, the assembly 2 comprises first sections 10, extending along the assembly 2, the first sections 10 being completely filled with the filling compound 8 between the jacket 6 and the insulated conductors 4. Further, the assembly 2 comprises second sections 12, extending along the assembly 2, the second sections 12 being void of filling compound between the jacket 6 and the insulated conductors 4. In these illustrated embodiments, comprising 7 insulated conductors 4, between the insulated conductors 4 interspaces are formed. The interspaces in the first sections 10 are completely filled with the filling compound 8. The interspaces in the second sections 12 are void of filling compound. Thus, the assembly 2 is intermittently completely filled with filling compound 8.

As may be clearly seen in FIG. 1b, in the first sections 10, the filling compound 8 completely fills all interspaces between the insulated conductors 4 as well as all spaces between the jacket 6 and the insulated conductors 4. In the first sections 10 in a cross section perpendicular to an extension of the assembly 2 thus, no cavities are present. The filling compound 8 in the first sections 10 water-tightly seals the second sections 12 from each other. Thus, any water inside the jacket 6 in the second sections 12 is prevented from passing the first sections 10.

Along the assembly 2, the first sections 10 and the second sections 12 may be distributed at a ratio of 1/20-1/5. That is, between 1/20 and 1/5 of a length along the assembly 2 may comprise first sections 10 and the remainder may comprise second sections 12. According to some embodiments, along the assembly 2 the first sections 10 and the second sections 12 may be distributed at a ratio of about 1/10. That is, about 1/10 of a length along the assembly 2 may comprise first sections 10 and the remainder may comprise second sections 12.

Provided purely as an example, the first sections 10 may have lengths of 5-25 cm. According to some embodiments, the first sections 10 may have lengths of about 15 cm.

According to embodiments, the at least two insulated conductors 4 may comprise a polyolefin material.

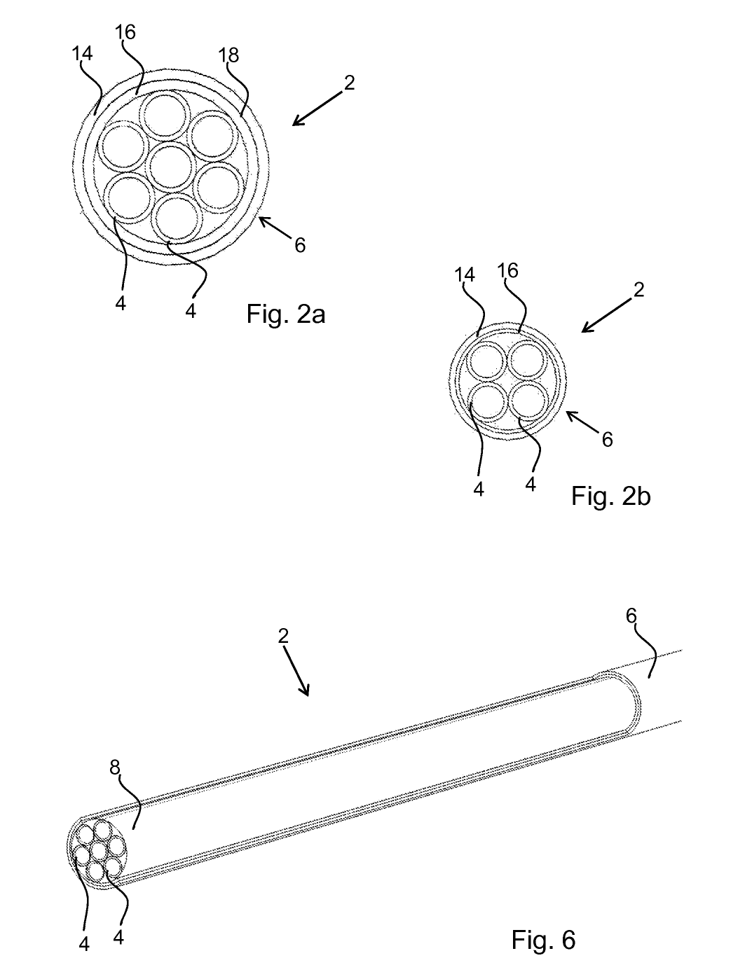

FIGS. 2a and 2b illustrate enlarged cross sections of insulated conductor assemblies 2 according to embodiments. Herein, the insulated conductor assembly 2 may alternatively be referred to as the assembly 2. The FIG. 2a embodiments correspond to the embodiments of FIGS. 1a and 1b, i.e. an assembly 2 comprising 7 conductors 4. The FIG. 2b embodiments comprise 4 conductors 4.

The jacket 6 may comprise a first layer 14 and second layer 16. For instance, the jacket 6 may comprise a Polypropylene based layer, and a Polyethylene based layer. Alternatively, the jacket 6 may comprise only one layer or more than two layers.

According to embodiments, the jacket 6 may comprise an aluminium layer 18. The aluminium layer 18 e.g. may comprise an aluminium foil. The aluminium layer 18 may be arranged between the first and second layers 14, 16, as illustrated in FIG. 2b. Alternatively, the aluminium layer 18 may be arranged on an inside of the second layer 16. Similarly, the jacket 6 may comprise a copper layer.

The insulated conductor assembly 2 may comprise at least one duct 4 adapted to receive an optical fibre or an electric conductor. Thus, in the illustrated embodiments at least one of the reference numbers 4 may refer to a duct 4. The jacket 6 encloses also the at least one duct 4.

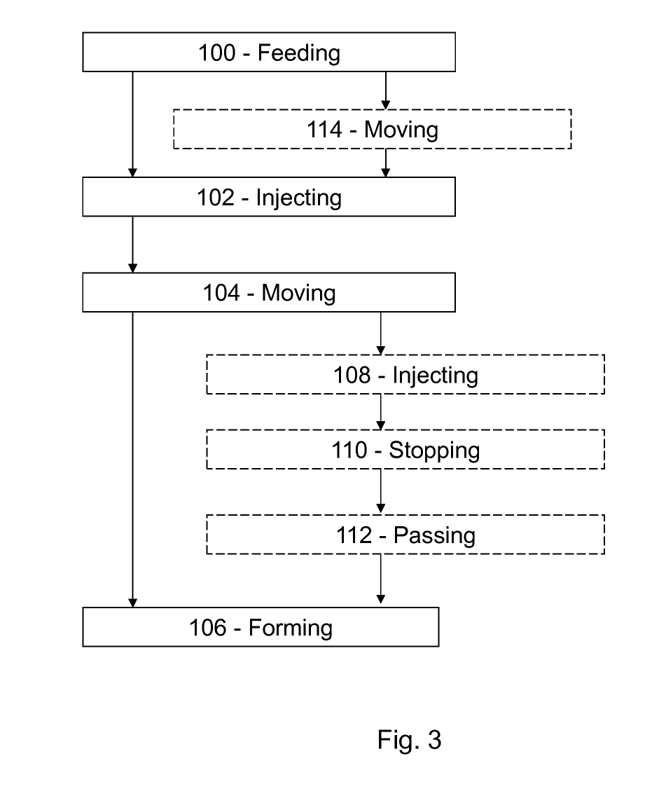

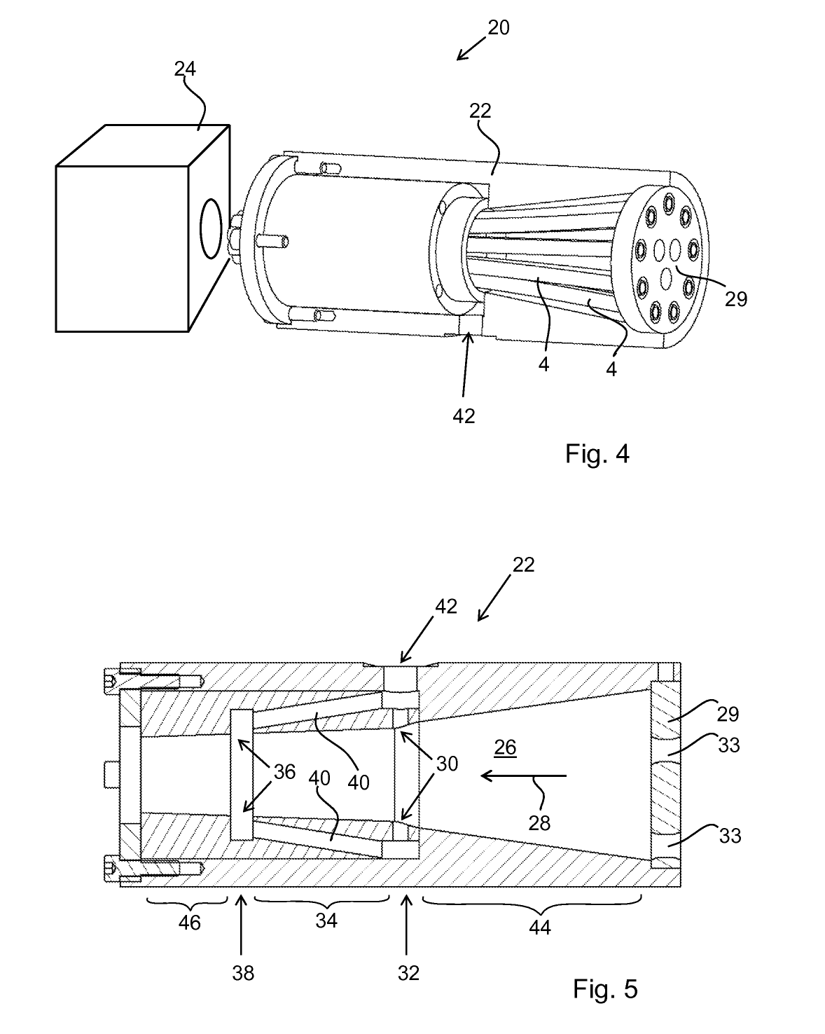

FIG. 3 illustrates schematically embodiments of a method of manufacturing a insulated conductor assembly. The method may for instance be performed in a manufacturing arrangement as described below in connection with FIGS. 4 and 5.

The method comprises:
feeding (100) at least three insulated conductors along a feeding direction through a passage of a die, the at least three insulated conductors being separated from each other at a first position of the die,
injecting (102) a first amount of filling compound into the passage at the first position,
moving (104) the at least three insulated conductors towards each other at a first portion of the die, the first portion being arranged after the first position seen along the feeding direction, and
forming (106) a jacket around the at least three insulated conductors and the filling compound.

As mentioned initially, the method ensures that interspaces between the at least three insulated conductors are filled with filling compound. As a result, the method produces an insulated conductor assembly with filling compound between the insulated conductors, i.e. an insulated conductor assembly that prevents water from being transported along the insulated conductor assembly. Herein, the insulated conductor assembly 2 may alternatively be referred to as the assembly 2. It is to be noted that assemblies 2 intermittently completely filled with filling compound, as described in connection with FIGS. 1a and 1b, as well as assemblies 2 completely filled with filling compound along their entire length, as described below in connection with FIG. 6, may be manufactured using the method according to these embodiments. The filling compound may be a compound which is heated prior to the injecting into the passage. For instance, the filling compound may be the compound Euromelt 322, ECA No: MVK01214 from the manufacturer Henkel Adhesive Technologies AB.

According to embodiments, the method may further comprise:
injecting (108) a second amount of filling compound into the passage at a second position of the die, the second position being arranged after the first portion, seen along the feeding direction.

According to embodiments, the method may further comprise:
intermittently stopping (110) the injecting (102) the first amount of filling compound and the injecting (108) the second amount of filling compound while continuing the feeding (100) and the forming (106), to thereby form an insulated conductor assembly comprising first sections completely filled with the filling compound between the jacket and the at least three insulated conductors as well as between the at least three insulated conductors, and second sections void of filling compound between the jacket and the at least three insulated conductors as well as between the at least three insulated conductors. In this manner an insulated conductor assembly 2 intermittently completely filled with filling compound, as described in connection with FIGS. 1a and 1b, may be manufactured.

According to embodiments, the method may further comprise:
passing (112) the at least three insulated conductors and the filling compound through a second portion of the die, the second portion being arranged after the second position, seen along the feeding direction. In this manner the filling compound may be distributed evenly in the second portion along the insulated conductors of the insulated conductor assembly prior to forming (106) the jacket around the at least three insulated conductors and the filling compound.

According to embodiments, the method may further comprise:
moving (114) the at least three insulated conductors towards each other at a converging portion of the die, the converging portion being arranged before the first position, seen along the feeding direction. In this manner the insulated conductors may be feed to the die from spread apart positions and be subjected to an initial converging in the converging portion of the die prior to the moving (104) the at least three insulated conductors towards each other at the first portion of the die.

According to embodiments, the first portion of the die may be converging along the feeding direction. In this manner the insulated conductors may be gradually moved towards each other as they pass along the first portion.

According to embodiments, the feeding 100 may comprise feeding at least one duct 4 along the feeding direction 28 through the passage 26 of the die 22. Thus, an insulated conductor assembly comprising both insulated conductors and ducts may be manufactured according to the method.

FIG. 4 illustrates embodiments of a manufacturing arrangement 20 for manufacturing an insulated conductor assembly, e.g. an insulated conductor assembly 2 as discussed above in relation to FIGS. 1a and 1b or an insulated conductor assembly as discussed below in connection with FIG. 6. The manufacturing arrangement 20 comprises a die 22 and a jacket forming arrangement 24. In FIG. 4 the die 22 is illustrated in a partial cross section. The jacket forming arrangement 24 is well known in the art and thus, only schematically illustrated in FIG. 4. FIG. 5 illustrates a cross section through the die 22.

The die 22 comprises a passage 26 extending through the die 22 for feeding at least three insulated conductors 4 along a feeding direction 28 through the passage 26. In the illustrated embodiments the passage 26 is adapted for feeding 12 insulated conductors 4 there through. A guiding plate 29 for the insulated conductors 4 is provided at an inlet end of the die 22. The guiding plate 29 comprises 12 through holes 33, one each for each insulated conductor 4. Thus, the insulated conductors 4 are orderly lead into the passage 26 of the die 22. The passage 26 of the die 22 is wider at the inlet end for the at least three insulated conductors than at an outlet end for the at least three insulated conductors and the filling compound.

The die 22 comprises a first injection arrangement 30 for filling compound arranged at a first position 32 along the feeding direction 28, and a first portion 34 of the die 22. The first injection arrangement 30 is connected to the passage 26. The first portion 34 is arranged after the first position 32, seen along the feeding direction 28. The first portion 34 is arranged to move the at least three insulated conductors 4 towards each other during manufacturing of an insulated conductor assembly in the manufacturing arrangement 20. The first portion 34 of the die 22 is converging along the feeding direction 28. Thus, the insulated conductors 4 are moved towards each other as they pass through the first portion 34.

Through the first injection arrangement 30, filling compound is arranged to be injected into the passage 26 of the die 22. At the first position 32 the at least three insulated conductors 4 are separate from each other. Thus, the filling compound is injected between the insulated conductors 4 before the first portion 34. In the first portion 34 the at least three insulated conductors 4 are moved towards each other. Thus, interspaces between the at least three insulated conductors 4 are filled with filling compound in an insulated conductor assembly manufactured in the die 22. In the jacket forming arrangement 24 a jacket may be formed around the at least three insulated conductors 4 to form an insulated conductor assembly with filling compound between the insulated conductors 4.

The die 22 comprises a second injection arrangement 36 for filling compound arranged at a second position 38 of the die 22 along the feeding direction. The second injection arrangement (36) is connected to the passage (26). The second position is 38 arranged after the first portion 34 of the die 22, seen along the feeding direction 28. In these embodiments the second injection arrangement 36 is interconnected with the first injection arrangement via channels 40. In this manner the die 22 need only comprise one filling compound inlet 42, from which filling compound is conducted to the first and second injection arrangements 30, 36.

The die 22 comprises a converging portion 44, the converging portion 44 being arranged before the first position 32, seen along the feeding direction 28, wherein the converging portion 22 is arranged for moving the at least three insulated conductors 4 towards each other. Along the converging portion 44 thus, the insulated conductors 4 may be displaced from initial positions in the guiding plate 29 at the inlet end of the die 22 to positions at a distance from each other suitable for injecting the filling compound between the insulated conductors 4 at the first position 32.

The die 22 comprises a second portion 46, the second portion 46 being arranged after the second position 38, seen along the feeding direction 28. The filling compound may thus be distributed evenly along the outer insulated conductors 4 in the second portion 46 during manufacturing of an insulated conductor assembly. The conductors and the filling compound thus may form a smooth foundation for the jacket of the insulated conductor assembly to be formed thereon in the jacket forming arrangement 24.

As mentioned, the passage 26 extends through the die 22. The passage 26 extends through the first portion 34. The passage 22 extends through the converging portion 44. The passage 22 extends through the second portion 46. In essence, the insulated conductors 4 are widely spread when entering the passage 26. At the first position 32 the filling compound will penetrate the interspaces. In the first portion 34, the insulated conductors 4 will be forced towards each other, and the filling compound will spread to the outer side of the insulated conductors 4.

In the manufacturing arrangement 20 the passage 26 may be adapted for feeding at least one duct 4 along the feeding direction 28 through the die 22. Thus, an insulated conductor assembly comprising both insulated conductors and ducts may be manufactured in the manufacturing arrangement 20.

FIG. 6 illustrates a partial cross section through an insulated conductor assembly 2 according to embodiments. Herein, the insulated conductor assembly 2 may alternatively be referred to as the assembly 2. The assembly 2 comprises at least three insulated conductors 4, a jacket 6 enclosing the at least three insulated conductors 4, and a filling compound 8 arranged between the jacket 6 and the at least three insulated conductors 4. A conductor of an insulated conductor is adapted to transmit an optical signal or an electric current. Filling compound 8 is further arranged between the at least three insulated conductors 4 to completely fill out interspaces therebetween. The assembly 2 is thus, void of cavities.

As opposed to the embodiments of FIGS. 1a and 1b, the assembly 2 of the embodiments illustrated in FIG. 6 do not comprise sections corresponding to the second sections 12 void of filling compound. The assembly 2 illustrated in FIG. 6 is completely filled with filling compound along its entire length.

However, a modification of the FIG. 6 embodiments would render these embodiments similar to the FIGS. 1a and 1b embodiments. With reference to FIGS. 1a and 1b, in such modified embodiments, first spaces between the jacket 6 and the at least three insulated conductors 4 are intermittently filed with the filling compound 8, and the interspaces are intermittently filed with the filling compound such that the assembly 2 comprises first sections 10 completely filled with the filling compound 8 between the jacket 6 and the at least three insulated conductors 4 as well as between the at least three insulated conductors 4, and second sections 12 void of filling compound between the jacket 6 and the at least three insulated conductors 4 as well as between the at least three insulated conductors 4. Such an assembly 2 is partially void of cavities.

According to embodiments, the assembly 2 may be manufactured according to the method discussed in connection with FIG. 3.

According to embodiments, along the assembly 2 the first sections 10 and the second sections 12 may be distributed at a ratio of 1/20-1/5. That is, between 1/20 and 1/5 of a length along the assembly 2 may comprise first sections 10. The remainder of the length along the assembly 2 may comprise second sections 12.

According to embodiments, the filling compound in the first sections 10 water-tightly seals the second sections 12 from each other.

According to embodiments, the first sections 10 and the second sections 12 may be distributed at a ratio of about 1/10.

According to embodiments, the at least three insulated conductors 4 may comprise a polyolefin material.

According to embodiments, the jacket 6 may comprises a Polypropylene based layer, and Polyethylene based layer.

According to embodiments, the jacket 6 may comprise an aluminium layer 18.

According to embodiments, the jacket 6 comprises a copper layer 18.

According to embodiments, the insulated conductor assembly 2 may comprise at least one duct 4 adapted to receive an optical fibre or an electric conductor. The jacket 6 encloses the at least one duct 4. Thus, an insulated conductor assembly comprising both insulated conductors and ducts may be provided.

Example embodiments described above may be combined as understood by a person skilled in the art. Although reference has been made to example embodiments, many different alterations, modifications and the like will become apparent for those skilled in the art. Therefore, it is to be understood that the foregoing is illustrative of various example embodiments and that the invention is defined only the appended claims.

As used herein, the term “comprising” or “comprises” is open-ended, and includes one or more stated features, elements, steps, components or functions but does not preclude the presence or addition of one or more other features, elements, steps, components, functions or groups thereof.

It will be understood that although the terms first, second, etc. may be used herein to describe various portions, layers and/or sections, these portions, layers and/or sections should not be limited by these terms. These terms are only used top distinguish one portion, layer or section from another portion, layer or section. Thus, a portion, layer or section discussed herein could be termed a second portion, layer or section without departing from the teachings herein.

1. An insulated conductor assembly comprising:
at least two insulated conductors;
a jacket enclosing the at least two insulated conductors; and
a filling compound arranged between the jacket and the at least two insulated conductors;
wherein first sections extend along the insulated conductor assembly, the first sections being completely filled with the filling compound between the jacket and the at least two insulated conductors; and
wherein second sections extend along the insulated conductor assembly, the second sections being void of filling compound between the jacket and the at least two insulated conductors.

2. The insulated conductor assembly according to claim 1, wherein interspaces are formed between the at least two insulated conductors, the interspaces in the first sections being completely filled with the filling compound, and wherein the interspaces in the second sections are void of filling compound.

3. The insulated conductor assembly according to claim 1, wherein the filling compound in the first sections water-tightly seals the second sections from each other.

4. The insulated conductor assembly according to claim 1, wherein along the insulated conductor assembly the first sections and the second sections are distributed at a ratio of 1/20-1/5.

5. The insulated conductor assembly according to claim 4, wherein along the insulated conductor assembly the first sections and the second sections are distributed at a ratio of about 1/10.

6. The insulated conductor assembly according to claim 1, wherein the at least two insulated conductors comprise a polyolefin material.

7. The insulated conductor assembly according to claim 1, wherein the jacket comprises a Polypropylene based layer, and/or a Polyethylene based layer.

8. The insulated conductor assembly according to claim 1, wherein the jacket comprises an aluminium layer.

9. The insulated conductor assembly according to claim 1, wherein the jacket comprises a copper layer.

10. The insulated conductor assembly according to claim 1, comprising at least one duct adapted to receive an optical fibre or an electric conductor, and wherein the jacket encloses the at least one duct.

11. A method of manufacturing an insulated conductor assembly, the method comprising:
feeding at least three insulated conductors along a feeding direction through a passage of a die, the at least three insulated conductors being separated from each other at a first position of the die,
injecting a first amount of filling compound into the passage at the first position,
moving the at least three insulated conductors towards each other at a first portion of the die, the first portion being arranged after the first position seen along the feeding direction, and
forming a jacket around the at least three insulated conductors and the filling compound.

12. The method according to claim 11, comprising:
injecting a second amount of filling compound into the passage at a second position of the die, the second position being arranged after the first portion, seen along the feeding direction.

13. The method according to claim 12, comprising:
intermittently stopping the injecting the first amount of filling compound and the injecting the second amount of filling compound while continuing the feeding and the forming, to thereby form an insulated conductor assembly comprising first sections completely filled with the filling compound between the jacket and the at least three insulated conductors as well as between the at least three insulated conductors, and second sections void of filling compound between the jacket and the at least three insulated conductors as well as between the at least three insulated conductors.

14. The method according to claim 12, comprising:
passing the at least three insulated conductors and the filling compound through a second portion of the die, the second portion being arranged after the second position, seen along the feeding direction.

15. The method according to claim 11, comprising:
moving the at least three insulated conductors towards each other at a converging portion of the die, the converging portion being arranged before the first position, seen along the feeding direction.

16. The method according to claim 11, wherein the first portion of the die is converging along the feeding direction.

17. The method according to claim 11, wherein the feeding comprise feeding at least one duct along the feeding direction through the passage of the die.

18. A manufacturing arrangement for manufacturing an insulated conductor assembly, the manufacturing arrangement comprising:
a die comprising a passage extending through the die for feeding at least three insulated conductors along a feeding direction there through; and
a jacket forming arrangement,
wherein the die comprises a first injection arrangement for filling compound arranged at a first position along the feeding direction and a first die portion of the die,
wherein the first injection arrangement is connected to the passage, and
wherein the first portion is arranged after the first position seen along the feeding direction, the first portion being arranged to move the at least three insulated conductors towards each other.

19. The manufacturing arrangement according to claim 18, wherein the passage is wider at an inlet end for the at least three insulated conductors than at an outlet end for the at least three insulated conductors and the filling compound.

20. The manufacturing arrangement according to claim 18, wherein the die comprises a second injection arrangement for filling compound arranged at a second position of the die along the feeding direction, the second position being arranged after the first portion of the die, seen along the feeding direction, and wherein the second injection arrangement is connected to the passage.

21. The manufacturing arrangement according to claim 18, wherein the die comprises a converging portion, the converging portion being arranged before the first position, seen along the feeding direction, wherein the converging portion is arranged for moving the at least three insulated conductors towards each other.

22. The manufacturing arrangement according to claim 21, wherein the die comprises a second portion, the second portion being arranged after the second position, seen along the feeding direction.

23. The manufacturing arrangement according to claim 18, wherein the first portion of the die is converging along the feeding direction.

24. The manufacturing arrangement according to claim 18, wherein the passage is adapted for feeding at least one duct along the feeding direction through the die.

25-35. (canceled)
